(19) United States
(12) Patent Application Publication
(10) Pub. No.: US 2025/0321510 A1
(43) Pub. Date: Oct. 16, 2025

(54) IMAGE FORMING APPARATUS

(71) Applicant: CANON KABUSHIKI KAISHA, Tokyo (JP)

(72) Inventor: Daigo Yamauchi, Kanagawa (JP)

(21) Appl. No.: 19/170,252

(22) Filed: Apr. 4, 2025

(30) Foreign Application Priority Data
Apr. 8, 2024 (JP) 2024-062298
Feb. 3, 2025 (JP) 2025-016288

(51) Int. Cl. G03G 15/01; G03G 21/16

(52) U.S. Cl. CPC G03G 15/0173; G03G 21/1652

(57) ABSTRACT

An image forming apparatus has a rotary including first and second trays supporting the first and second cartridges respectively which are displaced between first and second positions, and a circuit including first and second tray contact members and including a detector. The first and second cartridges include conductive first and second cartridge contact members, respectively. When the first tray is located at the first position and the first cartridge is supported by the first tray, the first cartridge contact member and the first tray contact member come into contact with each other, and thus a signal in the circuit is detected. When the first tray is located at the first position and the second cartridge is supported by the first tray, the second cartridge contact member and the first tray contact member do not come into contact with each other.

### BACKGROUND OF THE INVENTION

### Field of the Invention

The present invention relates to an image forming apparatus that forms an image on a sheet.

### Description of the Related Art

A rotary development method is known that forms a color image by rotating a rotary provided with a plurality of developing rollers in an image forming apparatus of an electrophotographic method. Japanese Patent Laid-Open No. 2007-183305 and Japanese Patent Laid-Open No. 2008-096852 describe an image forming apparatus that includes a rotary, in which a plurality of developing devices including developing rollers are stored, and toner cartridges (toner storage containers) that are attachable to and detachable from the respective developing devices and store consumable materials (toner) of a plurality of colors.

However, with the configuration described in the aforementioned documents, if a toner cartridge, or a developer container, of a certain color is attached to a wrong developing device, that is to say, a developing device to which a toner cartridge of a color different from that color is supposed to be attached, there is a possibility that toner colors are mixed inside the developing device.

Furthermore, if the shapes of the toner cartridges are changed on a per-color basis to prevent attachment of a toner cartridge to a wrong developing device as a solution to the aforementioned issue, dies for the respective containers become necessary, thereby leading to a cost increase attributed to the increase in the dies.

The present invention prevents a developer container from being placed at a wrong attachment position while suppressing an increase in the cost of the developer container.

### SUMMARY OF THE INVENTION

An aspect of the present invention provides an image forming apparatus to/from which a first cartridge and a second cartridge are attachable/detachable, the first cartridge storing a first developer, and the second cartridge storing a second developer, the image forming apparatus comprising: a rotary including a first developing chamber configured to store the first developer supplied from the first cartridge, and a second developing chamber configured to store the second developer supplied from the second cartridge; a first tray by which the first cartridge is attachably/detachably supported, and which is displaced, relative to the rotary, between a first position where the first cartridge is located outside the rotary and a second position where the first cartridge is located inside the rotary, the first tray including a first tray contact member; a second tray by which the second cartridge is attachably/detachably supported, and which is displaced, relative to the rotary, between a third position where the second cartridge is located outside the rotary and a fourth position where the first cartridge is located inside the rotary, the second tray including a second tray contact member; and a circuit including the first tray contact member or the second tray contact member and including a detector, wherein the first cartridge includes a conductive first cartridge contact member, the second cartridge includes a conductive second cartridge contact member, in a case where the first cartridge is supported by the first tray in a state where the first tray is located at the first position, the first cartridge contact member and the first tray contact member come into contact with each other, in a case where the first tray contact member and the first cartridge contact member have come into contact with each other, a first current is generated in the circuit, and the detector detects a signal that is based on the first current, and in a case where the second cartridge is supported by the first tray in a state where the first tray is located at the first position, the second cartridge contact member and the first tray contact member do not come into contact with each other, and the first current is not generated in the circuit.

Furthermore, another aspect provides an image forming apparatus to/from which a first cartridge and a second cartridge are attachable/detachable, the first cartridge storing a first developer, and the second cartridge storing a second developer, the image forming apparatus comprising: a rotary including a first developing chamber configured to store the first developer supplied from the first cartridge, and a second developing chamber configured to store the second developer supplied from the second cartridge; a first tray by which the first cartridge is attachably/detachably supported, and which is displaced, relative to the rotary, between a first position where the first cartridge is located outside the rotary and a second position where the first cartridge is located inside the rotary, the first tray including a first tray contact member; a second tray by which the second cartridge is attachably/detachably supported, and which is displaced, relative to the rotary, between a third position where the second cartridge is located outside the rotary and a fourth position where the first cartridge is located inside the rotary, the second tray including a second tray contact member; and a circuit including the first tray contact member or the second tray contact member and including a detector, wherein the first cartridge includes a conductive first cartridge contact member, the second cartridge includes a conductive second cartridge contact member, in a case where the first cartridge is supported by the first tray in a state where the first tray is located at the first position, the first cartridge contact member and the first tray contact member come into contact with each other, in a case where the first tray contact member and the first cartridge contact member have come into contact with each other, a first current is generated in the circuit, and the detector detects a signal that is based on the first current, and in a case where the second cartridge is supported by the first tray in a state where the first tray is located at the first position, the second cartridge contact member and the first tray contact member come into contact with each other, a second current different from the first current is generated in the circuit, and the detector detects a signal that is based on the second current.

Further features of the present invention will become apparent from the following description of exemplary embodiments (with reference to the attached drawings).

### BRIEF DESCRIPTION OF THE DRAWINGS

FIG. 1 is a cross-sectional diagram showing an image forming apparatus.

FIG. 2 is a cross-sectional diagram of a toner cartridge and a developing unit.

FIG. 3A is a cross-sectional diagram of a rotary and the surroundings thereof.

FIG. 3B is a cross-sectional diagram of the rotary and the surroundings thereof.

FIG. 4 is an external view of the rotary.

FIG. 5A is an external view of an image forming apparatus body.

FIG. 5B is an external view of the image forming apparatus body.

FIG. 5C is an external view of the image forming apparatus body.

FIG. 6 is a cross-sectional diagram of the rotary and the surroundings thereof at the time of exchange of a toner cartridge.

FIG. 7 is a perspective view showing the arrangement of trays inside the rotary.

FIG. 8 is a cross-sectional diagram showing the arrangement of trays inside the rotary.

FIG. 9A is a perspective view showing a driving configuration for insertion and removal of trays.

FIG. 9B is a perspective view showing the driving configuration for insertion and removal of trays.

FIG. 10A is a cross-sectional diagram showing the driving configuration for insertion and removal of trays.

FIG. 10B is a cross-sectional diagram showing the driving configuration for insertion and removal of trays.

FIG. 11 is a perspective view showing a configuration of contacts of a tray and a toner cartridge.

FIG. 12A is a perspective view showing connection between a tray contact and the body.

FIG. 12B is a perspective view showing connection between a tray contact and the body.

FIG. 13A is a schematic diagram showing the positions of contacts of trays and toner cartridges.

FIG. 13B is a schematic diagram showing the positions of contacts of trays and toner cartridges.

FIG. 14 is a circuit diagram of electrical connection among a control unit, a tray, and a toner cartridge according to a second embodiment.

FIG. 15 is a block diagram showing a control configuration of the image forming apparatus.

FIG. 16 is a flowchart of a control procedure at the time of exchange of a toner cartridge in the image forming apparatus.

FIG. 17A is a diagram showing an example in which a toner cartridge has been attached to a tray in a first embodiment.

FIG. 17B is a diagram showing an example in which a toner cartridge has been attached to a tray in the first embodiment.

FIG. 18 is a circuit diagram of electrical connection among a control unit, a tray, and a toner cartridge according to the first embodiment.

FIG. 19 is a schematic diagram of connection between a control unit and a second spring.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

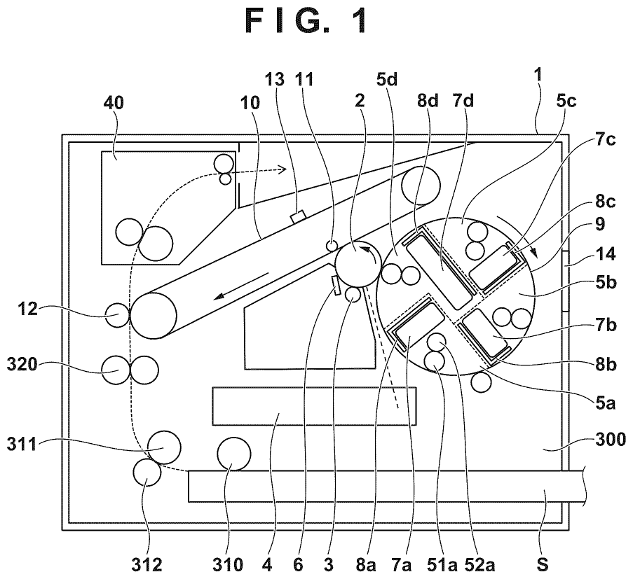

Using FIG. 1 to FIG. 13B, an image forming apparatus of the present embodiment will be described.

### Overall Configuration of Image Forming Apparatus

An image forming apparatus pertaining to the present embodiment will be described. Below, a color laser beam printer including four developing units is exemplarily presented as an image forming apparatus including a plurality of developing units.

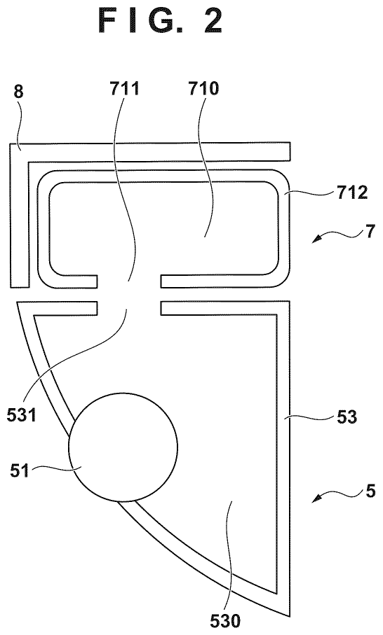

Using FIG. 1 and FIG. 2, a schematic configuration and an image forming operation of the color laser beam printer will be described. FIG. 1 is a schematic cross-section of the color laser beam printer.

As shown in FIG. 1, an image forming apparatus body 1 includes a drum-shaped electrophotographic photosensitive member 2 (hereinafter referred to as a photosensitive drum 2). A charging roller 3, an exposure device 4, four developing units 5a to 5d, and a cleaning unit 6 are disposed around the photosensitive drum 2. The charging roller 3 is charging means for uniformly charging the photosensitive drum 2. The exposure device 4 is exposure means for irradiating the photosensitive drum 2 with laser light corresponding to image information. As a result of irradiating the charged photosensitive drum 2 with laser light, electrostatic latent images are formed on the photosensitive drum 2. The developing units 5a to 5d are developing means for visualizing the electrostatic latent images formed on the photosensitive drum 2 by developing them using toner of corresponding colors. The cleaning unit 6 is cleaning means for removing toner remaining on the surface of the photosensitive drum 2.

The developing units 5a to 5d include developing rollers 51a to 51d, respectively. Note that in FIG. 1, only the developing roller 51a included in the developing unit 5a is pointed. Also, toner cartridges 7a to 7d acting as developer containers storing developers (or color agents) of respective color components, which are toner in the present example, are attached to the developing units 5a to 5d. The toner cartridges 7a to 7d store yellow toner, magenta toner, cyan toner, and black toner, respectively. That is to say, the developing units 5a to 5d develop the electrostatic latent images formed on the photosensitive drum 2 using the yellow toner, the magenta toner, the cyan toner, and the black toner, respectively.

Each of the toner cartridges 7a to 7d is a consumable material that is exchanged when the toner stored therein has been depleted. Here, the four developing units 5a to 5d are provided in a rotary 9 that is a rotatable or turn-style support member, that is to say, a rotary support member. The rotary may be referred to as a rotary body. Also, the rotary 9 includes trays 8a to 8d, and the toner cartridges 7a to 7d are attachably/detachably held by the trays 8a to 8d. The trays 8a to 8d are supported so that they can be slidably moved to the outside of the rotary 9, as will be described later. That is to say, it can be said that the rotary 9 is a storage for the trays 8a to 8d. As shown in FIG. 2, the toner cartridges 7a to 7d held by the trays 8a to 8d are configured to be attachable to and detachable from the rotary 9 as a result of slidably moving the trays 8a to 8d to the outside of the rotary 9 with use of a driving source M2 (not shown) and a drive transmission mechanism. When the trays 8a to 8d have been brought to the outside of the image forming apparatus body 1 through an opening of a door 14, the toner cartridges can be exchanged by an operator at that location.

Note that the trays 8 are associated with toner cartridges to be attached thereto in accordance with corresponding toner colors, respectively. In view of this, the colors of toner stored in the toner cartridges may be referred to as the colors (or color components) of the toner cartridges, and the colors of the toner cartridges that are respectively attached to the trays may be referred to as the colors (or color components) of the trays. Also, toner may be distinguished on a per-color basis, and referred to as a first developer, a second developer, or the like. Furthermore, a toner cartridge 7 may also be distinguished on a per-color basis, and referred to as a first cartridge, a second cartridge, or the like.

FIG. 2 is a conceptual diagram showing a configuration for supplying toner from a toner cartridge 7 to a developing unit 5. In FIG. 2, in order to show a configuration related to one toner cartridge regardless of color, signs a to d indicating the respective colors are omitted, even with respect to parts that are provided on a per-color basis. The same goes for descriptions other than FIG. 2. A toner frame body 712 of the toner cartridge 7 held by the tray 8 includes a toner storage unit 710 and a discharge opening 711 that communicates with the toner storage unit 710. The storage unit may be referred to as a container. A developing frame body 53 of the developing unit 5 includes a developing-side storage unit 530 and a receiving opening 531 that communicates with the developing-side storage unit. As will be described later, the discharge opening 711 opposes the receiving opening 531 in a state where the toner cartridge 7 has moved to an attachment position. When the toner is supplied from the toner cartridge 7 to the developing unit 5, at least a part of the receiving opening 531 is positioned underneath at least a part of the discharge opening 711. Then, the toner stored in the toner storage unit 710 is discharged from the discharge opening 711, and the toner discharged from the discharge opening 711 enters the developing-side storage unit 530 through the receiving opening 531. It is desirable that the toner cartridge 7 includes a toner-side sealing member, which is not shown, for covering the discharge opening 711. Also, it is desirable that the developing unit 5 includes a developing-side sealing member, which is not shown, for covering the receiving opening 531.

It is desirable that, in a state where the toner cartridge 7 is not attached to the developing unit 5, the discharge opening 711 and the receiving opening 531 be covered with the toner-side sealing member and the developing-side sealing member, respectively, as to as suppress the discharge of toner from the discharge opening 711 and the receiving opening 531. The developing-side storage unit 530 may be referred to as a developing chamber. In this case, it may be referred to as a first developing chamber, a second developing chamber, or the like to make distinction for each of the colors of stored toner.

### Image Forming Operation of Image Forming Apparatus

The image forming operation in the present embodiment will be described. First, the photosensitive drum 2 is rotated in an arrow direction shown in the photosensitive drum 2 of FIG. 1 (counterclockwise) in synchronization with rotation of an intermediate transfer belt 10. Then, the surface of the photosensitive drum 2 is uniformly charged by the charging roller 3. Along with this, the exposure device 4 emits laser light for a yellow image, thereby forming a yellow electrostatic latent image on the photosensitive drum 2.

At the same time as this formation of the electrostatic latent image, the rotary 9, which is a rotary support member capable of rotating, is rotated, and the yellow developing unit 5a is stopped at a developing position that opposes the photosensitive drum 2. Note that the rotary 9 is rotated by a non-illustrated driving source. At the developing position, the developing roller 51a provided in the yellow developing unit 5a is in contact with the photosensitive drum 2, and develops the electrostatic latent image using the yellow toner. That is to say, the rotary 9 rotates in an arrow direction of FIG. 1 (clockwise) while supporting the developing units 5a to 5d, thereby causing the four supported developing units 5a to 5d to move in sequence to the developing position opposing the photosensitive drum 2, one by one. The yellow developing unit 5a located at the developing position causes the developing roller 51a to develop the electrostatic latent image formed on the photosensitive drum 2 with use of the yellow toner stored therein. An RS roller 52a rotates in the direction that is the same as, or the reverse of, the direction of the developing roller 51a; consequently, toner remaining on the developing roller 51a is stripped off, and new toner is supplied.

After the electrostatic latent image has been developed, a primary transfer roller 11 arranged inside the intermediate transfer belt 10 performs primary transfer of the yellow toner formed on the photosensitive drum 2 to the intermediate transfer belt 10.

In the foregoing manner, the primary transfer of the yellow toner image is completed. Thereafter, the developing units 5b to 5d of the respective colors magenta, cyan, and black are rotated and moved by rotation of the rotary 9 and stop at the developing position opposing the photosensitive drum 2, in sequence. Then, similarly to the case of yellow, the formation, development, and primary transfer of the electrostatic latent image are performed with respect to the colors magenta, cyan, and black, in sequence. As a result, toner images of four colors overlap one another on the intermediate transfer belt 10.

During the foregoing, a secondary transfer roller 12 is not in contact with the intermediate transfer belt 10. Furthermore, at this time, a cleaning apparatus 13 that removes remaining toner on the intermediate transfer belt 10 is not in contact with the intermediate transfer belt 10, either.

Meanwhile, sheets S as recording mediums are stacked and stored in a sheet storage unit 300 provided in a lower part of the image forming apparatus body 1. The sheets S are, for example, sheet-like mediums (sheet materials or cut sheets) obtained by cutting paper or the like in a predetermined size, and fed by a pickup roller 310. After each individual sheet S has been separated by a feed roller 311 and a separation roller 312, it is sent to a conveyance roller pair 320. The conveyance roller pair 320 sends the fed sheet S to a nip portion between the intermediate transfer belt 10 and the secondary transfer roller 12. The toner images of four colors that overlap one another on the intermediate transfer belt 10 are collectively transferred to the surface of the conveyed sheet S (secondary transfer).

The sheet S on which the toner images have been transferred is sent to a fixing device 40. In the fixing device 40, heat and pressure are applied to the sheet S, and the toner images are fixed onto the sheet S. As a result, a color image is formed on the sheet S. Then, this sheet S is discharged from the fixing device 40.

As described above, in the image forming operation according to the present embodiment, a non-illustrated driving source rotates image creation units such as the photosensitive drum 2, the developing rollers 51a to 51d, and the intermediate transfer belt 10, paper feed/conveyance units such as the pickup roller 310, the feed roller 311, and the conveyance roller pair 320, and the fixing device 40.

### Rotary Configuration

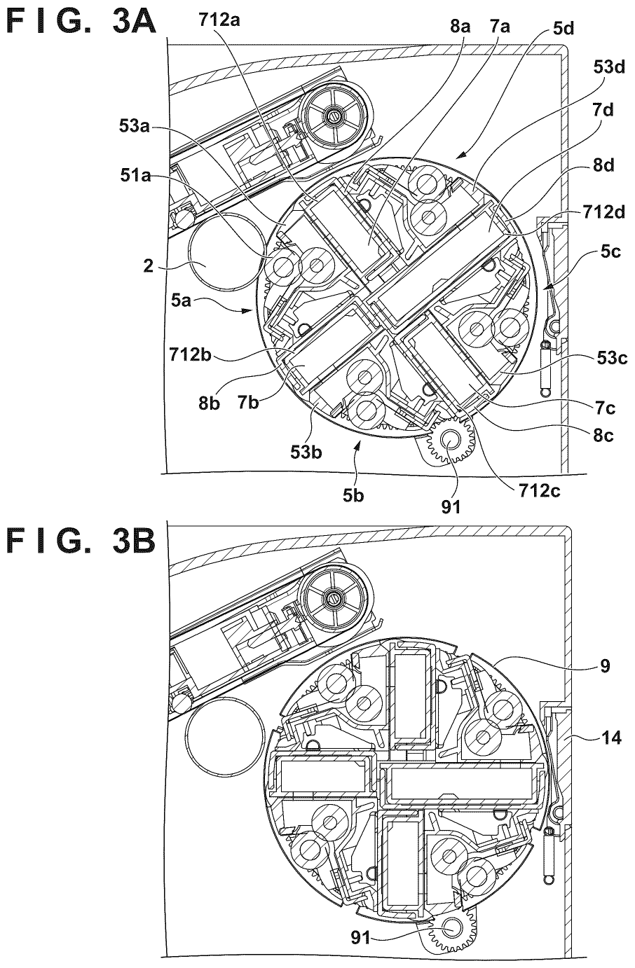

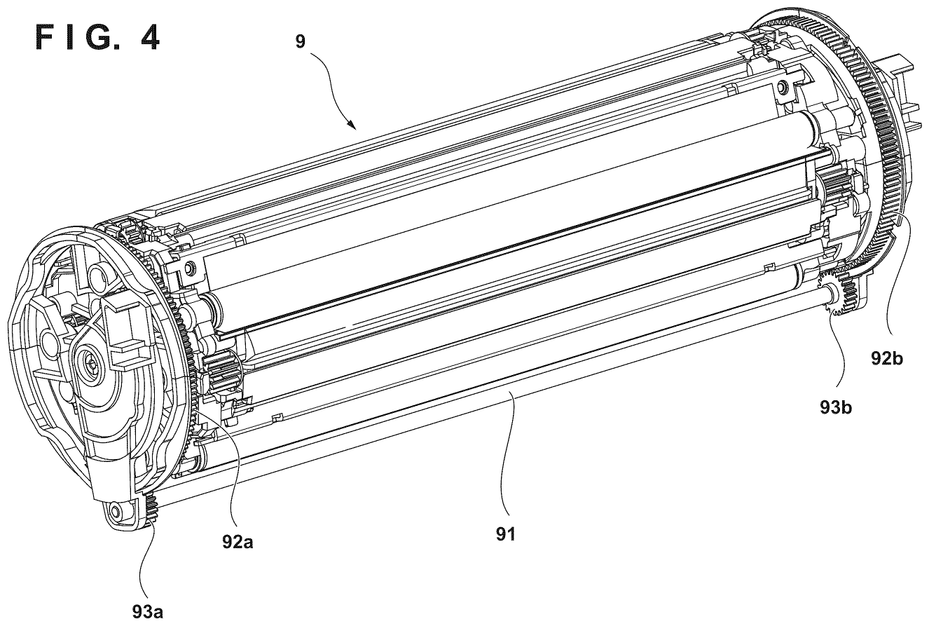

Using FIG. 3A to FIG. 4, a configuration of the rotary 9 will be described. FIG. 3A and FIG. 3B are cross-sectional diagrams of the rotary 9 and the surroundings thereof. FIG. 4 is an external view of the rotary 9.

As stated earlier, the toner cartridges 7a to 7d are attachable to and detachable from the rotary 9, and a user can exchange the toner cartridges 7a to 7d when toner inside the toner cartridges 7a to 7d has been depleted. At the time of exchange of a toner cartridge, the rotary 9 is stopped at a toner cartridge exchange position.

FIG. 3A shows a cross-section of the rotary 9 and the surroundings thereof in a state where the rotary 9 is stopped at the developing position. FIG. 3B shows a cross-section of the rotary 9 and the surroundings thereof in a state where the rotary 9 is stopped at the toner cartridge exchange position. As shown in FIG. 3A and FIG. 3B, the four trays 8a to 8d are arranged inside the rotary 9, and the toner frame bodies 712a to 712d of the toner cartridges 7a to 7d are held by the trays 8a to 8d, respectively. At this time, the toner cartridges 7a to 7d are in a state where they have been attached to the developing units 5a to 5d. In the present embodiment, the toner cartridge 7d storing black toner (hereinafter referred to as a black toner cartridge 7d) is larger in size than the toner cartridges of other colors, and capable of storing a large amount of toner. The toner cartridges of other colors are the toner cartridges 7a to 7c storing yellow toner, magenta toner, and cyan toner (hereinafter referred to as a yellow toner cartridge 7a, a magenta toner cartridge 7b, and a cyan toner cartridge 7c).

Therefore, the tray 8d that holds the black toner cartridge 7d is larger in size than the trays 8a to 8c that hold the yellow toner cartridge 7a, the magenta toner cartridge 7b, and the cyan toner cartridge 7c. That is to say, the four toner cartridges 7a to 7d and the trays 8a to 8d that have different sizes are arranged inside the rotary 9. The toner in the toner cartridges 7a to 7d is supplied to the developing frame bodies 53a to 53d of the developing units 5, and used by the developing rollers 51a to 51d for development.

Here, the rotary 9 is supported so as to be swingable around a swing shaft 91. At the developing position, the developing roller 51a is in contact with the photosensitive drum 2 as a non-illustrated force application member applies a force thereto. In the course of moving the rotary 9 to the toner cartridge exchange position by rotating it clockwise in the figure, a non-illustrated separation mechanism causes the rotary 9 to swing around the swing shaft 91, and the developing roller 51a becomes separated from the photosensitive drum 2. At the toner cartridge exchange position, the black toner cartridge 7d is stopped at a position that opposes the door 14 provided on the front surface of the image forming apparatus body 1. In this state, the user can exchange the black toner cartridge 7d by sliding and moving the tray 8d from the position of attachment to the developing unit 5d to the outside of the rotary 9. Note that a toner cartridge exchange operation will be described later.

Using FIG. 4, rotation and driving of the rotary 9 will be described. As shown in FIG. 4, disk gears 92a and 92b are formed at both ends of the rotary 9. Furthermore, rotary drive gears 93a and 93b are joined to both ends of the swing shaft 91 so as to be capable of transmitting the drive. Here, a non-illustrated driving source is transmitted to the rotary drive gear 93b, and the rotary drive gears 93a and 93b transmit a driving force to the disk gears 92a and 92b; as a result, the rotary 9 is rotated.

### Toner Cartridge Exchange Operation

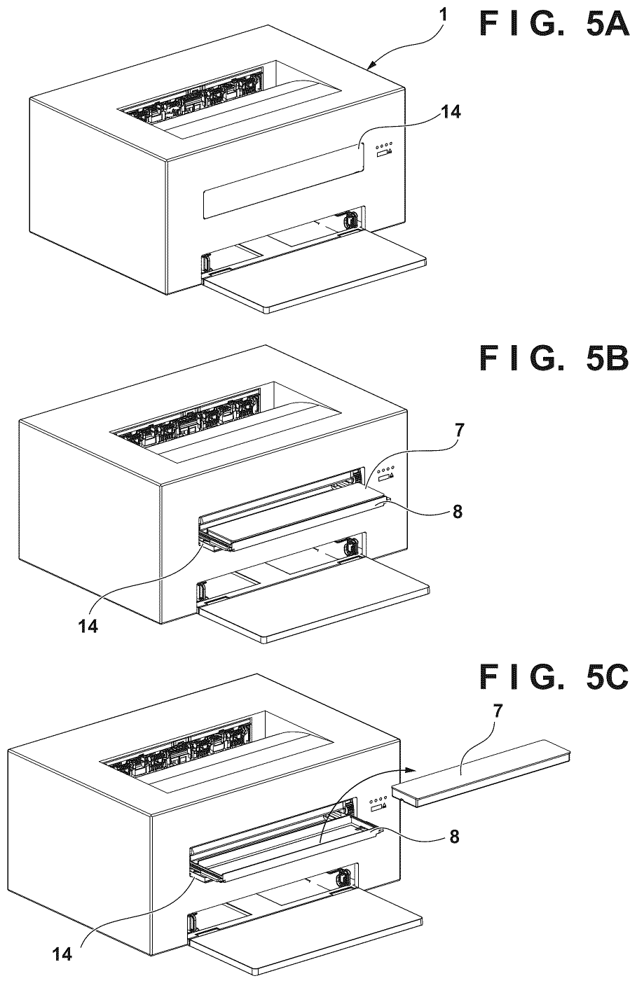

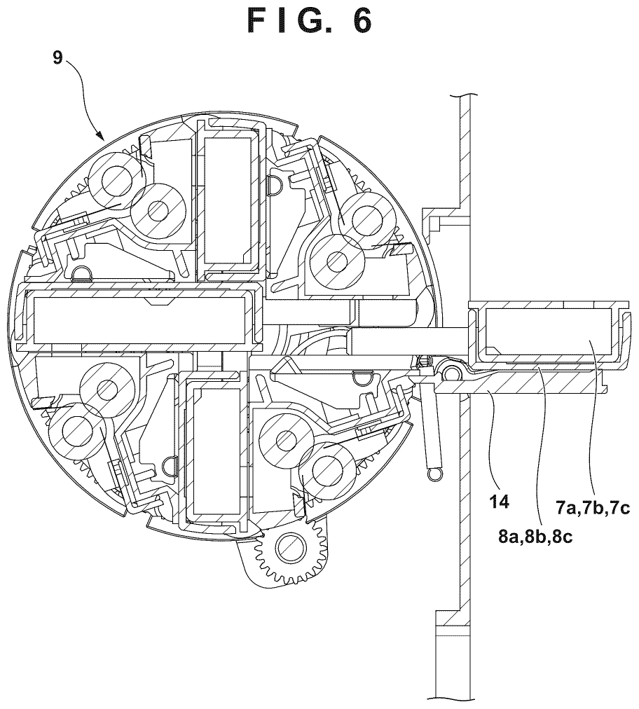

Using FIG. 5A to FIG. 6, the toner cartridge exchange operation will be described. FIG. 5A to FIG. 5C are external views of the image forming apparatus body 1. FIG. 6 is a cross-sectional diagram of the rotary and the surroundings thereof at the time of exchange of a toner cartridge.

FIG. 5A shows an external view of the image forming apparatus body 1 during the image forming operation and a standby state. At this time, the door 14 is in a closed state. FIG. 5B shows an external view of the image forming apparatus body 1 at the time of exchange of a toner cartridge. At this time, the door 14 is in an opened state, and a tray 8 and a toner cartridge 7 have moved to the outside of the image forming apparatus body 1.

The toner cartridge exchange operation will be described. First, when the user has issued an instruction for the toner cartridge exchange operation to the image forming apparatus body 1 (e.g., performed an operation of pressing an exchange button or the like), the rotary 9 is rotated and stopped at an exchange position of a toner cartridge 7 to be exchanged (a toner cartridge 7 in which toner has been depleted). Next, a driving source causes the tray 8 and the toner cartridge 7 to slide and move from the position of attachment to a developing unit 5 to the outside of the image forming apparatus body 1. At this time, the door 14 is supported so as to be pivotable relative to the image forming apparatus body 1, and the sliding movement of the tray 8 places the door 14 in the opened state (the state of FIG. 5B). Here, as the toner cartridge 7 is attachably/detachably held by the tray 8, the user can perform the exchange task by detaching the toner cartridge 7 from the tray 8 and attaching a new toner cartridge 7 as shown in FIG. 5C. Note that in a case where a plurality of toner cartridges 7 are to be exchanged, the exchange task can be performed by repeating the aforementioned operation.

FIG. 6 shows a cross-section of the rotary 9 and the surroundings thereof at the time of exchange of a toner cartridge. As shown in FIG. 6, at the time of exchange of a toner cartridge, as the user performs an operation of attaching/detaching the toner cartridge 7 via the tray 8, it is desirable that the entirety of the toner cartridge 7 protrudes out of the image forming apparatus body 1 through the front surface thereof.

### Arrangement of Trays Inside Rotary

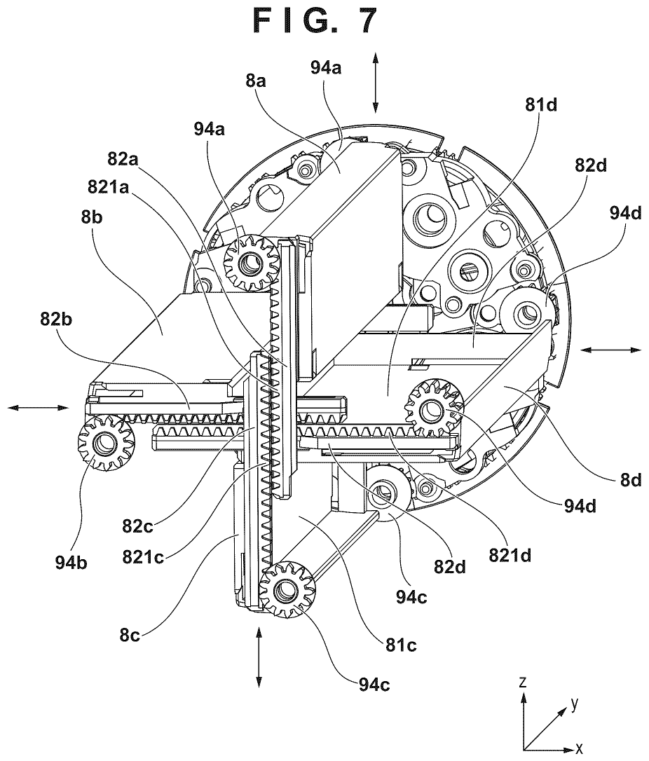

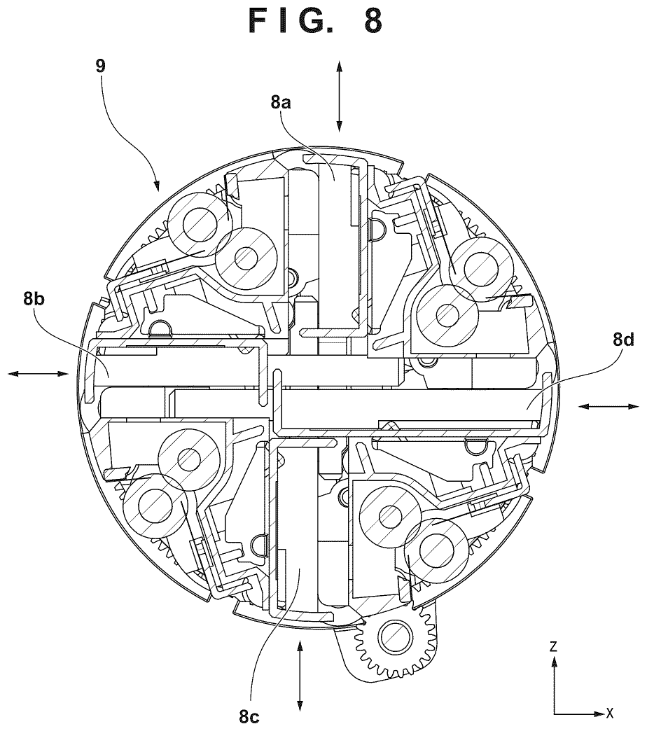

Using FIG. 7 and FIG. 8, the arrangement of the trays 8a to 8d inside the rotary 9 will be described.

FIG. 7 is a perspective view showing the arrangement of the trays 8a to 8d inside the rotary 9. FIG. 8 is a cross-sectional diagram showing the arrangement of the trays 8a to 8d inside the rotary 9.

As shown in FIG. 7, the trays 8a to 8d include toner cartridge holding portions 81a to 81d and tray rails 82a to 82d, respectively (the toner cartridge holding portions 81a and 81b are not shown). The tray rails 82a to 82d are provided at both ends of the toner cartridge holding portions 81a to 81d. Rack portions 821a to 821d are formed on the tray rails 82a to 82d. Furthermore, rack gears 94a to 94d are rotatably held inside the rotary 9, and the rack gears 94a to 94d respectively mesh with the rack portions 821a to 821d so as to be capable of transmitting the drive.

Also, as shown in FIG. 7 and FIG. 8, the four trays 8a to 8d are arranged inside the rotary 9 in such a manner that they lie on top of one another. Their respective tray insertion/removal directions are the directions of 90-degree rotation relative to one another (arrow directions in the figures). Therefore, each of a pair of the yellow tray 8a and the cyan tray 8c and a pair of the magenta tray 8b and the black tray 8d is held so as to be slidable and movable in the same direction. Each tray is displaced between a position where it is stored inside the rotary 9 and a position where it has been ejected to the outside of the rotary 9.

### Driving Configuration for Insertion/Extraction of Trays

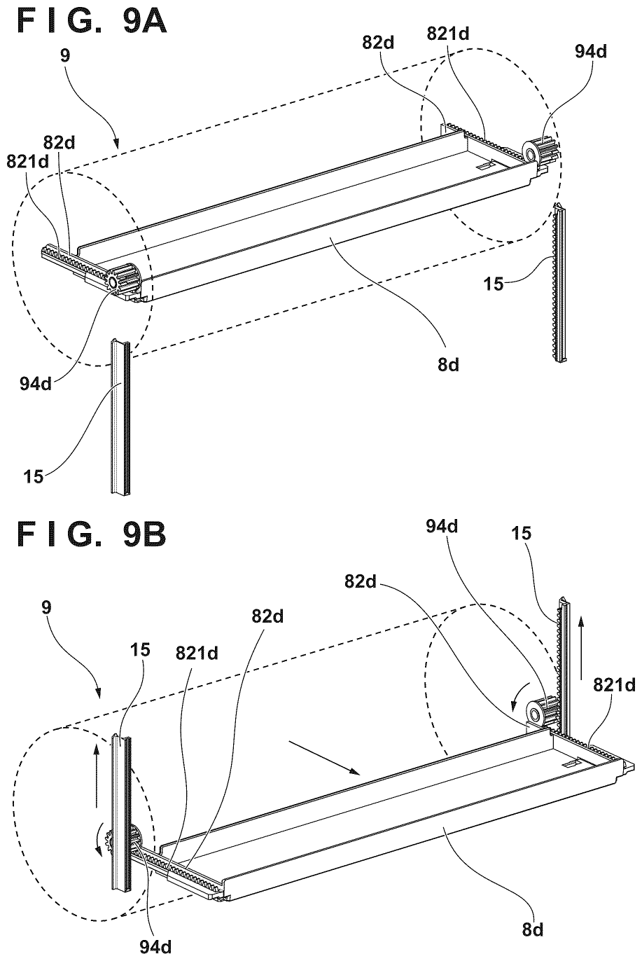

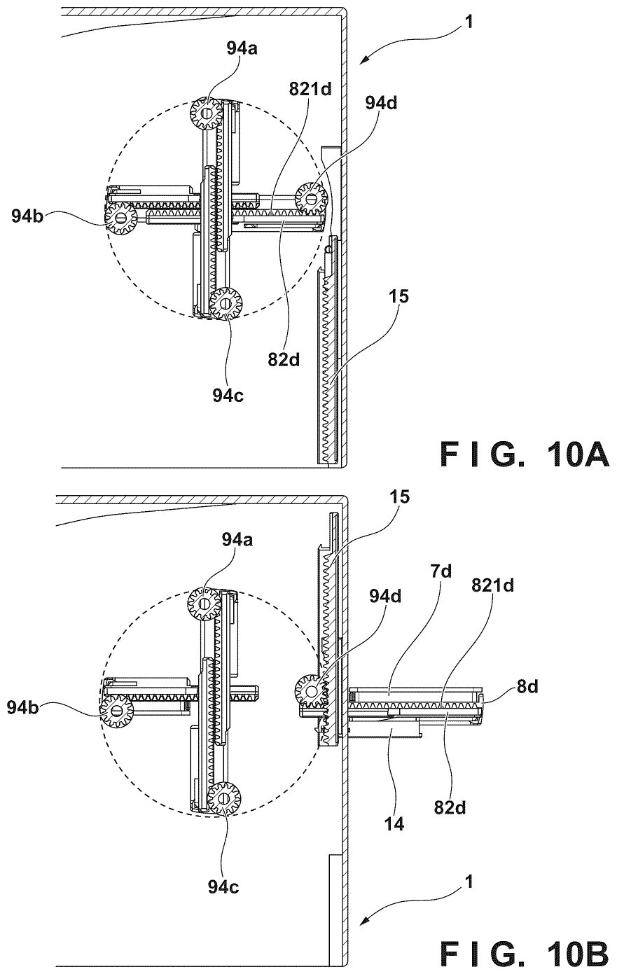

Using FIG. 9A to FIG. 10B, a driving configuration for insertion and removal of the trays 8a to 8d arranged inside the rotary 9 will be described. FIG. 9A and FIG. 9B are perspective views showing the driving configuration for insertion and removal of the trays. FIG. 10A and FIG. 10B are cross-sectional diagrams showing the driving configuration for insertion and removal of the trays.

FIG. 9A shows a state where the tray 8d is inside the rotary 9 (i.e., a state where the toner cartridge 7d has been attached to the developing unit 5d). FIG. 9B shows a state where the tray 8d has slid and moved to the outside of the rotary 9. As stated earlier, two rack portions 821d are formed at both ends. Furthermore, two rack gears 94d and two driving racks 15 are also arranged at positions corresponding to the rack portions 821d at both ends. The tray 8d is held so as to be slidable and movable relative to the rotary 9 in the direction parallel to the tray rails 82d. The driving racks 15 are held so as to be slidable and movable relative to the image forming apparatus body 1 in the up-down direction. Although only the tray 8d is shown among the four trays 8a to 8d here, a driving configuration for insertion and removal of the trays 8a to 8c is similar.

Using FIG. 10A and FIG. 10B, the following describes a tray insertion and removal operation for sliding and moving the tray 8d from the inside of the rotary 9 (the position where the toner cartridge 7d is attached to the developing unit 5d) to the outside thereof. The operation of insertion and removal of the tray 8d is performed by a non-illustrated driving source, the driving racks 15, the rack gears 94d, and the rack portions 821d. First, a driving force transmitted by the driving source causes the driving racks 15 to slide and move toward the upper side of the image forming apparatus body 1 and transmit the drive to the rack gears 94. The rack gears 94 rotate counterclockwise and transmit the drive to the rack portions 821d; consequently, the tray 8d slides and moves from the position of attachment of the toner cartridge 7d to the developing unit 5d toward the outside of the rotary 9.

Furthermore, an operation of sliding and moving the tray 8d to the inside of the rotary 9 after the toner cartridge has been exchanged can be performed by rotating and driving the driving source in the direction that is the reverse of the direction during the sliding movement of the tray 8d to the outside of the rotary 9. In this case, the driving racks slide and move toward the lower side of the image forming apparatus body 1; consequently, the tray 8d is retracted to the inside of the rotary 9. Note that the inside of the rotary 9 refers to the position where the toner cartridge 7d is attached to the developing unit 5d.

Also, a position of a toner cartridge 7 outside the rotary 9 may be referred to as a first position of a toner cartridge 7 or a tray 8, and a position of a toner cartridge 7 inside the rotary 9 may be referred to as a second position of a toner cartridge 7 or a tray 8. The first position and the second position are the positions of the tray 8 or the toner cartridge 7 shown in FIG. 10B and FIG. 10A, respectively. Furthermore, when focusing on a plurality of toner cartridges, a position of a toner cartridge 7 outside the rotary 9 may be referred to as a third position of a toner cartridge 7 or a tray 8. In this case, a position of a toner cartridge 7 inside the rotary 9 may be referred to as a fourth position of a toner cartridge 7 or a tray 8. For example, a direction in which a tray 8 is displaced from the second position to the first position can be referred to as a displacement direction (X direction).

The operation of insertion and removal of a tray 8 arranged inside the rotary 9 can be performed by rotating and driving a driving source in the forward and reverse directions as described above.

### Configuration of Contacts of Tray and Toner Cartridge

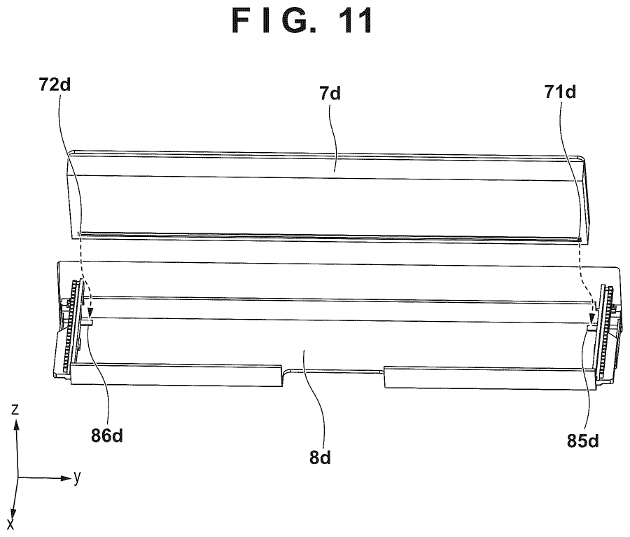

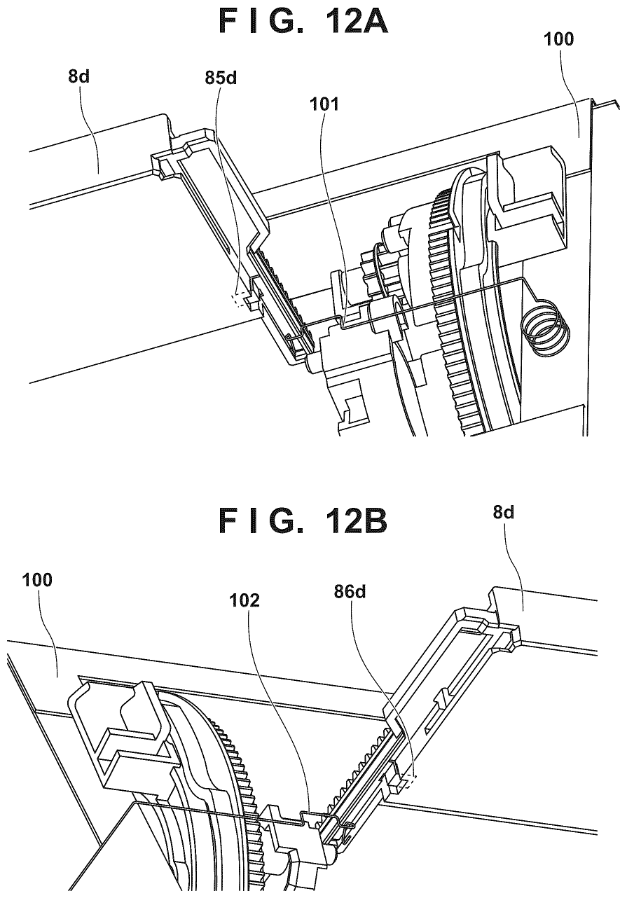

Using FIG. 11 to FIG. 12B, a configuration of contacts of the trays 8a to 8d and the toner cartridges 7a to 7d will be described. FIG. 11 is a perspective view showing a configuration of contacts of the tray 8d and the toner cartridge 7d.

FIG. 11 is a perspective view of a state where the toner cartridge 7d has been detached from the tray 8d as viewed from above the body. The toner cartridge 7d includes a first toner cartridge contact 71d and a second toner cartridge contact 72d, and the tray 8d includes a first tray contact 85d and a second tray contact 86d. Once the toner cartridge 7d has been attached to the tray 8d, the first toner cartridge contact 71d and the first tray contact 85d are connected, and the second toner cartridge contact 72d and the second tray contact 86d are connected.

FIG. 12A and FIG. 12B are perspective views showing connection between the first tray contact 85d and the second tray contact 86d and the body. FIG. 12A is a perspective view of a section of the first tray contact 85d, and FIG. 12B is a perspective view of a section of the second tray contact 86d. The body's first tray contact 85d is connected to the body frame 100 via a first spring 101, while the second tray contact 86d is connected to a non-illustrated electrical substrate, which is provided on the body side, via a second spring 102.

Once the toner cartridge 7d has been attached to the tray 8d, the first tray contact 85d is connected to the first toner cartridge contact 71d, and the second tray contact 86d is connected to the second toner cartridge contact 72d. This makes it possible to detect the attachment of the toner cartridge 7d to the tray 8d.

Note that the first tray contact 85d and the second tray contact 86d are made of a metallic sheet, and also function as rigid members of the tray 8d.

Although only the tray 8d and the toner cartridge 7d are shown among the four trays 8a to 8d and the four toner cartridges 7a to 7d here, a configuration of contacts of the trays 8a to 8c and the toner cartridges 7a to 7c is similar.

Note that the first tray contact 85d and the second tray contact 86d may be collectively referred to as a contacted portion or a tray contact member. In this case, the contacted portion may be referred to as a first contacted portion, a second contacted portion, or the like depending on the color of the tray. Furthermore, the first toner cartridge contact 71d and the second toner cartridge contact 72d that come into contact with the contacted portion may be collectively referred to as a contact portion or a cartridge contact member as opposed to the contacted portion included in the tray. In this case, the contact portion may be referred to as a first contact portion, a second contact portion, or the like depending on the color of the toner cartridge. The first contact portion is a conductive wire extending in the longitudinal direction of the first cartridge. The second contact portion is a conductive wire extending in the longitudinal direction of the second toner cartridge.

### Positions of Contacts of Tray and Toner Cartridge

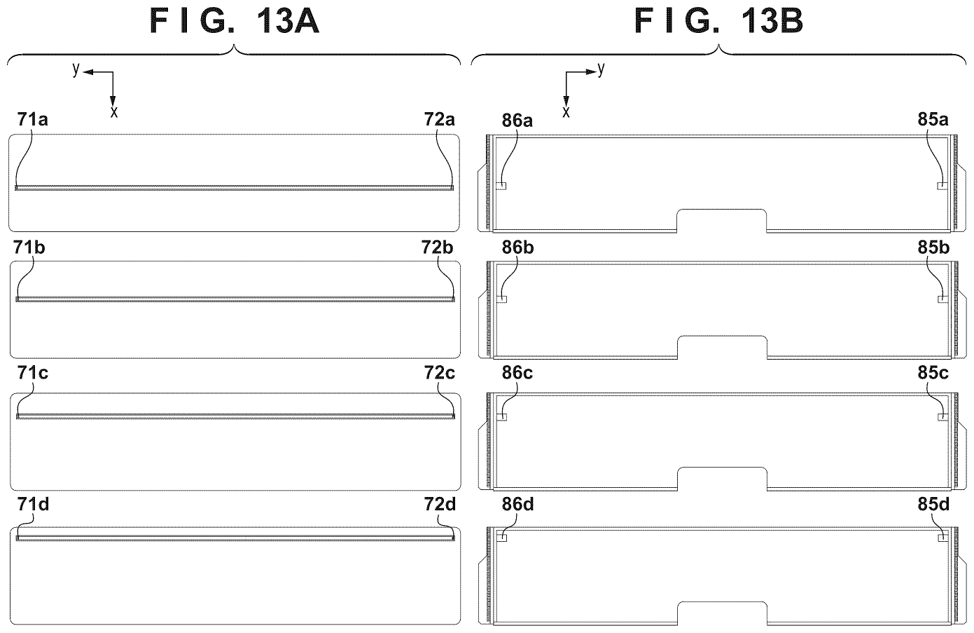

Using FIG. 13A and FIG. 13B, the positions of contacts of the trays 8a to 8d and the toner cartridges 7a to 7d will be described. FIG. 13A is a schematic diagram showing the positions of the contacts in each of the toner cartridges 7a to 7d, and FIG. 13B is a schematic diagram showing the positions of the contacts in each of the trays 8a to 8d.

In the trays 8a to 8d, the first tray contacts 85a to 85d are different in position from one another, and the first tray contact 85a is arranged at a position that does not overlap with the first tray contacts 85b to 85d in the x direction. The first tray contact 85b is arranged at a position that does not overlap with the first tray contacts 85c and 85d in the x direction. The first tray contact 85c is arranged at a position that does not overlap with the first tray contact 85d in the x direction.

Furthermore, in the trays 8a to 8d, the second tray contacts 86a to 86d are different in position from one another, and the second tray contact 86a is arranged at a position that does not overlap with the second tray contacts 86b to 86d in the x direction. The second tray contact 86b is arranged at a position that does not overlap with the second tray contacts 86c and 86d in the x direction. The second tray contact 86c is arranged at a position that does not overlap with the second tray contact 86d in the x direction. That is to say, both of the first tray contacts and the second tray contacts are arranged at positions that differ among different color components of the respective trays.

In the toner cartridges 7a to 7d, the first toner cartridge contacts 71a to 71d are different in position from one another. The first toner cartridge contact 71a is located in a site that connects to the first tray contact 85a, and the first toner cartridge contact 71b is located in a site that connects to the first tray contact 85b. The first toner cartridge contact 71c is located in a site that connects to the first tray contact 85c, and the first toner cartridge contact 71d is located in a site that connects to the first tray contact 85d.

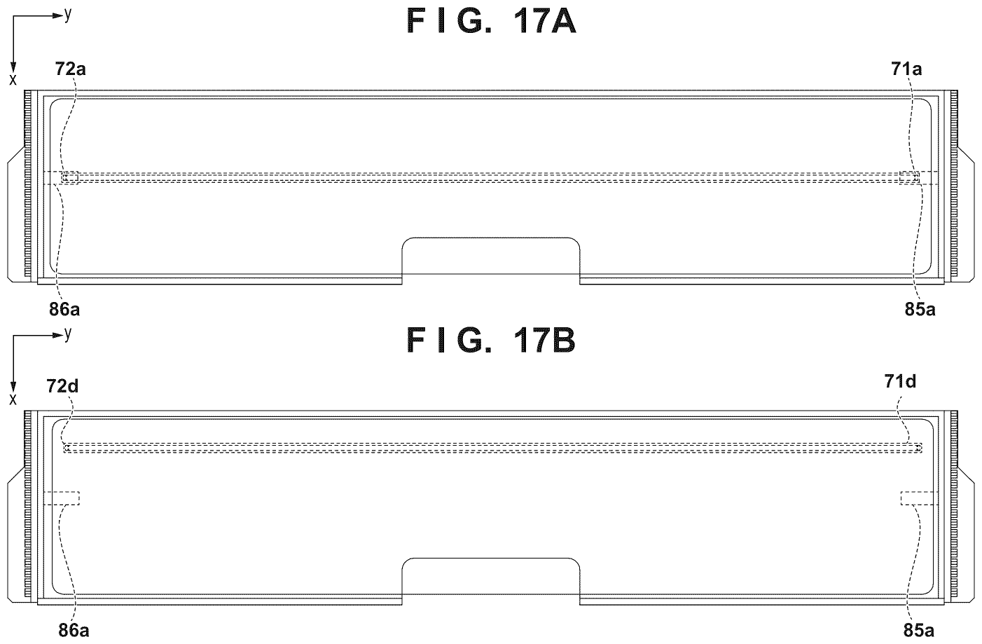

Furthermore, in the toner cartridges 7a to 7d, the second toner cartridge contacts 72a to 72d are different in position from one another. The second toner cartridge contact 72a is located in a site that connects to the second tray contact 86a, and the second toner cartridge contact 72b is located in a site that connects to the second tray contact 86b. The second toner cartridge contact 72c is located in a site that connects to the second tray contact 86c, and the second toner cartridge contact 72d is located in a site that connects to the second tray contact 86d. Also, the first toner cartridge contact 71 and the second toner cartridge contact 72 are connected by a conductive member, such as a conductive wire made of, for example, metal. Alternatively, both ends of the conductive member may be formed as the first toner cartridge contact 71 and the second toner cartridge contact 72, respectively. Such conductive wires are placed for the respective color components so that they are parallel relative to the direction perpendicular to the longitudinal direction of the conductive wires (i.e., the longitudinal direction of the cartridges). The purpose of this placement is to prevent contact between the first tray contact 85 and the first toner cartridge contact 71, and between the second tray contact 86 and the second toner cartridge contact 72, when a toner cartridge 7 of a certain color has been attached to a tray 8 of a different color. In other words, the contacts in each toner cartridge and each tray are provided so that a closed circuit is formed only in a case where a toner cartridge 7 has been attached to a tray 8 of the corresponding color. As an example, the following describes a case where the toner cartridge 7a has been attached to the tray 8a, and a case where the toner cartridge 7d has been attached to the tray 8a, using FIG. 17A and FIG. 17B. FIG. 17A is a schematic diagram of a case where the toner cartridge 7a has been attached to the tray 8a, and FIG. 17B is a schematic diagram of a case where the toner cartridge 7d has been attached to the tray 8a. As shown in FIG. 17A, in a case where the toner cartridge 7a has been attached to the tray 8a, the first toner cartridge contact 71a of the toner cartridge 7a is connected to the first tray contact 85a of the tray 8a. Also, in this case, the second toner cartridge contact 72a of the toner cartridge 7a is connected to the second tray contact 86a of the tray 8a. Next, as shown in FIG. 17B, in a case where the toner cartridge 7d has been attached to the tray 8a, the first toner cartridge contact 71d of the toner cartridge 7d is not connected to the first tray contact 85a of the tray 8a. Also, in this case, the second toner cartridge contact 72d of the toner cartridge 7d is not connected to the second tray contact 86a of the tray 8a.

In this way, for example, the second tray contact 86a and the second toner cartridge contact 72a are connected to each other in a case where the toner cartridge 7a has been attached to the tray 8a. However, in a case where other toner cartridges 7b to 7d have been attached thereto, the second tray contact 86a is not connected to the second toner cartridge contacts 72b to 72d; this makes it possible to detect whether the toner cartridge 7a has been attached to the tray 8a.

As described above, the first toner cartridge contacts 71a to 71d and the second toner cartridge contacts 72a to 72d are mutually connected, or a single conductive member, such as a metallic member. As a result, when the first toner cartridge contact and the second toner cartridge contact are connected to the first tray contact and the second tray contact, respectively, upon mounting the toner cartridge 7 on the tray 8, the first tray contact and the second tray contact are electrically coupled to each other. For example, if the first tray contact is connected to a power source of a predetermined voltage and the second tray contact is grounded via a load, the attachment of the toner cartridge can be detected from a potential of the second tray contact, and an identifiable detection signal can be generated for each color component. Needless to say, this is one example, and a toner cartridge can be also detected using other configurations.

Although the above has described a case where the second tray contact 86a is different in position in the x direction, a similar configuration can be adopted also when it is different in position in the y direction.

Also, although the above description has been provided under the assumption that the first toner cartridge contact 71 and the second toner cartridge contact 72 are at the ends of one conductive member, they are not limited to being at the ends, and they may be two different points located at positions that respectively correspond to the first tray contact and the second tray contact of the tray of the corresponding color.

Furthermore, the above has described a case where the first tray contacts 85a to 85d and the second tray contacts 86a to 86d are different in position from one another. In contrast, a similar configuration can be adopted also in a case where only the first tray contacts 85a to 85d are different in position from one another, or in a case where only the second tray contacts 86a to 86d are different in position from one another. That is to say, the conductive wires may be placed so that one end of the conductive wire of each color is at the same position, while the other end of each conductive wire is placed at a position that varies on a per-color basis. In this case, the first toner cartridge contacts 75a to 75d and the second toner cartridge contacts 76a to 76d are also placed respectively at positions corresponding to the first tray contacts 85a to 85d and the second tray contacts 86a to 86d. For example, the first toner cartridge contacts 75a to 75d are placed at the same position, and the second toner cartridge contacts 76a to 76d are located at different positions. Here, the first toner cartridge contacts and the second toner cartridge contacts may be switched. That is to say, assuming a state where the toner cartridges 7a to 7d of the respective colors lie on top of one another, the conductive wires connecting between the first toner cartridge contacts 75a to 75d and the second toner cartridge contacts 76a to 76d are arranged in a shape of a fan with a pivot represented by contacts on one side. In this way, assuming a state where the toner cartridges of the respective colors lie on top of one another, it is sufficient for the conductive wires connecting between the first toner cartridge contacts 75a to 75d and the second toner cartridge contacts 76a to 76d to be placed so that parts thereof do not overlap (lie on top of) one another. In addition, if the conductive wires are configured so that parts thereof that do not overlap one another come into contact with one of the first tray contacts 85 or the second tray contacts 86, the circuits of the trays become unique on a per-color basis. In this way, it is sufficient that the contacts of the toner cartridges 7 and the contacts of the trays 8 be provided so that a closed circuit is configured when a toner cartridge 7 has been placed on a tray 8 of the corresponding color, and a closed circuit is not configured otherwise. Note that as the conductive wires provided in the toner cartridges 7 electrically connect between contacts, the shape thereof need not be linear, and may be curved, for example.

In the above-described manner, a tray is in one-to-one association with a color of toner of a toner cartridge that can be detected when attached thereto. Furthermore, according to the above-described configuration, the toner cartridges that are respectively associated with the trays can be electrically detected. This makes it possible to perform control to, when a correct toner cartridge 7 has been attached, cause a tray 8 to slide and move to the inside of the rotary 9, from a state where it protrudes outside, by driving the driving source M2. Furthermore, it is also possible to perform control to, when a wrong toner cartridge 7 has been attached, refrain from causing the tray 8 to slide and move to the inside of the rotary 9 without driving the driving source M2.

### Control During Exchange of Toner Cartridge

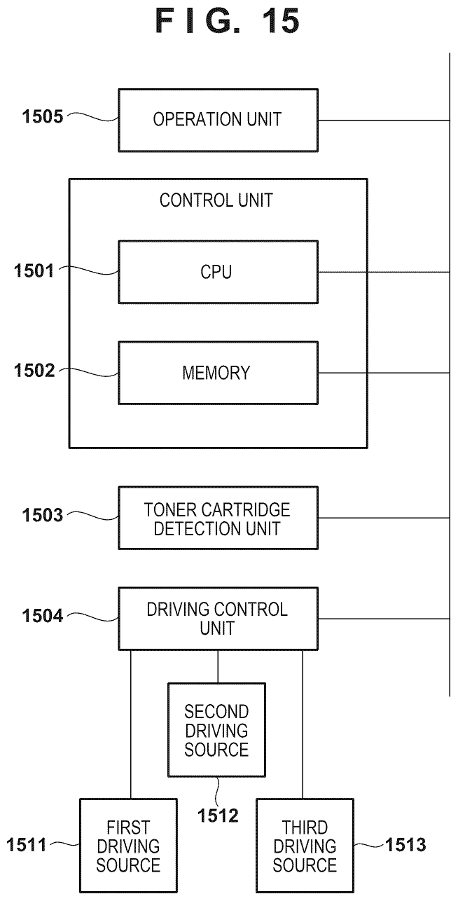

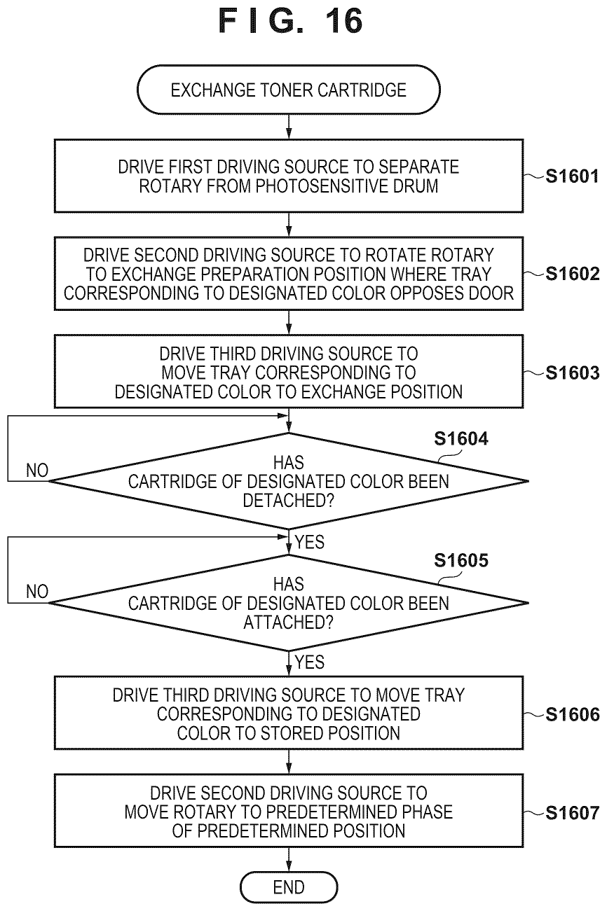

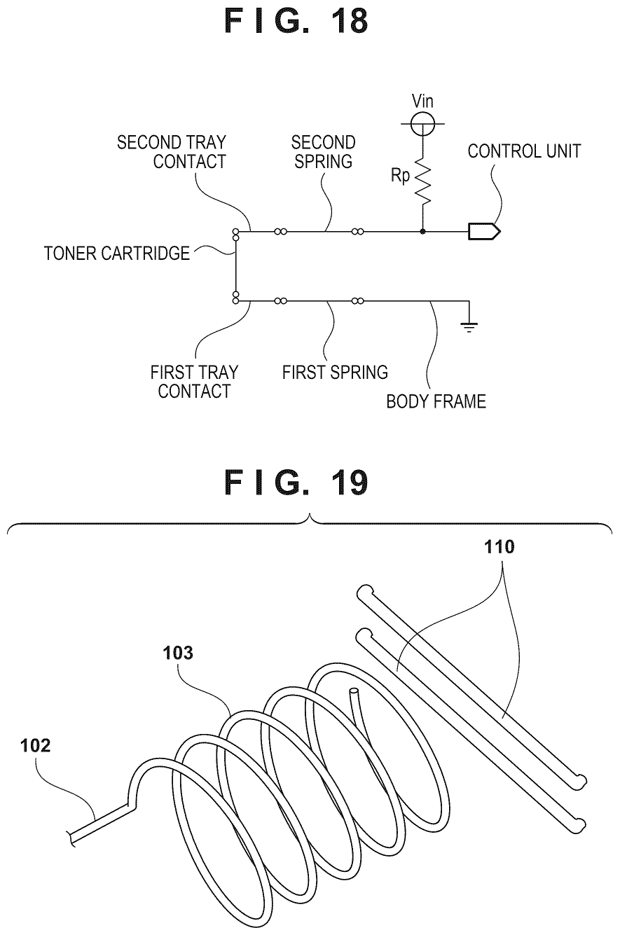

Next, a more detailed description of the above-described control during an exchange of a toner cartridge will be provided. FIG. 15 shows a configuration diagram of hardware of a control unit of the image forming apparatus that assists an exchange of a toner cartridge. FIG. 16 shows a control procedure performed by this control unit, FIG. 18 shows a circuit diagram of electrical connection from the control unit to a tray 8 and a toner cartridge 7, and FIG. 19 shows a schematic diagram of connection between the control unit and a second spring 102.

As shown in FIG. 18, the circuit is pulled up between the control unit and a second tray contact 86, a first tray contact 85 is connected to the body frame 100 via a first spring 101, and the body frame 100 is grounded. More specifically, a pull-up resistor Rp and a power source Vin are connected to a second spring 102. Note that FIG. 18 shows a configuration in which the control unit includes a toner cartridge detection unit 1503 shown in FIG. 15, which will be described later.

In a case where the toner cartridge 7 is not attached to the tray 8, the second tray contact 86 and the first tray contact 85 are not connected, and thus a current does not flow through the circuit of FIG. 18, and a signal level of HI is input to the control unit (or toner cartridge detection unit). When the corresponding toner cartridge 7 has been attached to the tray 8, the second tray contact 86 and the first tray contact 85 become connected via the toner cartridge 7, and thus a current flows through the circuit of FIG. 18, and a signal level of LOW is input to the control unit.

Also, as shown in FIG. 19, a spring portion 103 is formed at an end of the second spring 102 located on the opposite side of an end thereof that comes into contact with the second tray contact 86; when this spring portion 103 has come into contact with a contact 110 on the body side, the second spring 102 and the control unit are connected.

In FIG. 15, a CPU 1501 controls the image forming apparatus by executing a program stored in a memory 1502. Furthermore, the CPU 1501 controls the image forming apparatus by executing the procedure shown in FIG. 16 through the execution of the program. Therefore, the CPU 1501, or the CPU 1501 and the memory 1502, may be referred to as the control unit.

The toner cartridge detection unit 1503 is connected to a circuit that includes the first tray contacts 85a to 85d and the second tray contacts 86a to 86d, and detects a toner cartridge attached to a tray. For example, with the above-described configuration, the toner cartridge detection unit 1503 detects a toner cartridge that includes a first toner cartridge contact 71 and a second toner cartridge contact 72 located at positions corresponding to a first tray contact 85 and a second tray contact 86, and outputs a detection signal. The color of toner stored in the toner cartridge can be identifiably represented by a four-bit value, namely 1, 2, 4, or 8, by converting each of the potentials of the second tray contacts 86a to 86d into a digital one-bit value and inputting the same to a latch as this detection signal, for example. In this case, a state where the toner cartridge is not attached is represented by 0. It is sufficient to fill other digit positions with 0. In this way, the toner cartridge detection unit 1503 detects whether the toner cartridge 7 is attached or unattached, and the color thereof in a case where the toner cartridge 7 is attached, and then inputs the detection result to the CPU 1501. Note that the toner cartridge detection unit 1503 may be simply referred to as a detection unit.

Also, it is permissible to adopt a configuration in which the control unit includes the toner cartridge detection unit 1503 as shown in FIG. 18.

A driving control unit 1504 controls driving of driving sources, such as motors. The driving sources to be controlled include at least three driving sources. A first driving source 1511 is a driving source for causing the rotary 9 to swing around the swing shaft 91. The first driving source 1511 causes the rotary 9 to come into contact with or become separated from the photosensitive drum 2. The first driving source 1511 may be, for example, a motor, a solenoid, or the like.

A second driving source 1512 is a driving source for rotating the rotary 9. The second driving source 1512 is, for example, a motor, and rotates the rotary 9 by driving the rotary drive gears 93a and 93b. In control on rotation of the rotary 9, phases of the rotary 9 in a stopped state are also controlled. That is to say, for each of the four colors, there are a phase at the time of image formation shown in FIG. 3A, and a phase at the time of exchange of the toner cartridge 7 shown in FIG. 3B (this may be referred to as an exchange preparation position). Various methods can be used for this control on phases of the rotary 9. In one example thereof, a rotary encoder is mounted coaxially with the rotary 9, and a sensor indicating that the rotary 9 is at a reference phase is also provided. In this way, a phase of the rotary 9 can be recognized by monitoring the amount of rotation relative to the reference phase, and thus the rotary 9 can be stopped at a desired phase.

A third driving source 1513 is a driving source for causing the tray 8 to move between a stored position shown in FIG. 9A and an exchange position of the toner cartridge 7 shown in FIG. 9B (this is also simply referred to as an exchange position). The third driving source 1512 is, for example, a motor for driving the driving racks 15 upward or downward, and control on this driving includes control on a driving direction and ON/OFF of the driving. Also, position sensors may be provided on the tray 8, the driving racks 15, and the like so as to enable accurate positioning of the tray 8 at the stored position and the exchange position.

An operation unit 1505 is composed of, for example, a touch panel, and includes an input unit intended for an operator to perform inputs, and an output unit for presenting information to the operator. The output unit may be a display unit, such as a liquid crystal display panel, but may include, among others, a lamp like an LED, a speaker for outputting sounds, and the like. The operation unit 1505 allows the operator to designate an exchange of a toner cartridge, and a toner cartridge storing toner of a color to be exchanged. Note that the operation unit 1505 may be realized by a remote UI that is provided by a web server included in the image forming apparatus to an information processing apparatus acting as a terminal.

In addition, in the case of a configuration in which the door 14 is opened or closed by the operator, a door detection unit for detecting whether the door 14 is in an opened state or a closed state may be provided. However, the door detection unit is not necessary in a case where the operator need not open or close the door 14, like in the case of a configuration in which the tray 8 push-opens the door 14 when the tray 8 moves to the exchange position of the toner cartridge 7, for example.

Note that FIG. 15 shows an example of a configuration for control; the targets of control in the image forming apparatus are not limited to those shown in FIG. 15, and another configuration can also be adopted as a circuit configuration for control.

FIG. 16 shows an example of a procedure realized by the control unit, especially the CPU 1501, executing the program stored in the memory 1502 at the time of exchange of a toner cartridge 7. For example, when the operation unit 1505 has issued an instruction on an exchange of a toner cartridge and a color thereof, this instruction acts as a trigger to start processing of FIG. 16.

First, in response to the instruction, the first driving source is driven to separate the rotary 9 from the photosensitive drum 2 (step S1601). Next, the second driving source is driven to cause the rotary 9 to rotate and be located at the exchange preparation position where a tray 8 corresponding to a color designated as an exchange target (referred to as a designated color) opposes the door 14 (step S1602). Next, the third driving source is driven to cause the tray 8 corresponding to the designated color, namely the tray 8 located at the exchange preparation position, to move from the stored position where it is stored in the rotary 9 to the exchange position where it is located outside the door 14 (step S1603). At this time, in the case of a structure in which the door 14 is opened by the operator, the operation of step S1603 is performed after the door detection unit has detected that the door 14 is in the opened state.

In this state, the toner cartridge 7 of the designated color is located at an exchangeable position, and thus a standby for the operator's exchange of the toner cartridge takes place. The exchange task includes detachment of the toner cartridge that has been attached, and attachment of a new toner cartridge. In view of this, first, whether the toner cartridge 7 of the designated color has been detached is determined (step S1604). The determination of step S1604 can be made because once the toner cartridge 7 has been detached, the first tray contact 85 and the second tray contact 86 become insulated from each other, and thus a detection signal thereof becomes 0 with the structure of the toner cartridge detection unit 1503 according to the above-described example.

If the toner cartridge 7 of the designated color has been detached, whether a new toner cartridge 7 of the designated color has been attached is determined (step S1605). As stated earlier, the respective positions of the first tray contact 85 and the second tray contact 86, and the respective positions of the first toner cartridge contact 71 and the second toner cartridge contact 72, vary on a per-color basis. That is to say, even if a toner cartridge 7 of a color other than the designated color has been attached to the tray 8, the first tray contact 85 and the second tray contact 86 remain insulated from each other. Conversely, if the toner cartridge 7 of the designated color has been attached to the tray 8 of the designated color, conduction is achieved between the first tray contact 85 and the second tray contact 86, and the toner cartridge detection unit 1503 outputs a detection signal with a value corresponding to the color. The determination of step S1605 can be made based on this signal.

In a case where it is determined that the toner cartridge 7 has been exchanged, the third driving source is driven to cause the tray 8 of the designated color that has been located at the exchange position to move to the stored position in the rotary 9 (step S1606). Then, the second driving source and the first driving source are driven to cause the rotary 9 to move to a predetermined position and also rotate to a predetermined phase (step S1607). Step S1607 may not be executed because the rotary 9 moves in response to an instruction for exchanging a toner cartridge of another color or a start of image formation.

As described above, an exchange to a toner cartridge of a color that is not a color of an exchange target is not possible. Specifically, if an exchange to a toner cartridge of a color that is not a color of an exchange target has been performed, processing does not proceed past step S1604 of FIG. 16, and the tray 8 remains outside at the exchange position and is not retracted even after the exchange of the toner cartridge. Therefore, neither an exchange of a toner cartridge 7 of another color, nor image formation, can be performed. Accordingly, the toner cartridges may have the same shape regardless of color. In the present embodiment, only the black toner cartridge is different in shape from toner cartridges of other colors due to its larger capacity; however, if the black toner cartridge has the same shape as the toner cartridges of other colors, then the toner cartridges of the same shape can be used for all colors. Therefore, it is not required to manufacture the same number of dies of the toner cartridges as the colors, and a mistake in a color of a toner cartridge to be exchanged can be prevented while suppressing a cost increase.

### Second Embodiment

### Configuration in Which Toner Cartridges Have Electrical Characteristics

In the configuration of the first embodiment, a state where a correct toner cartridge has been attached to a tray is detected because the positions of contacts of each of the trays 8a to 8d and the toner cartridges 7a to 7d vary depending on the corresponding color. On the other hand, it is also possible to detect whether a correct toner cartridge has been attached to a tray by changing electrical characteristics, even if the positions of contacts are the same.

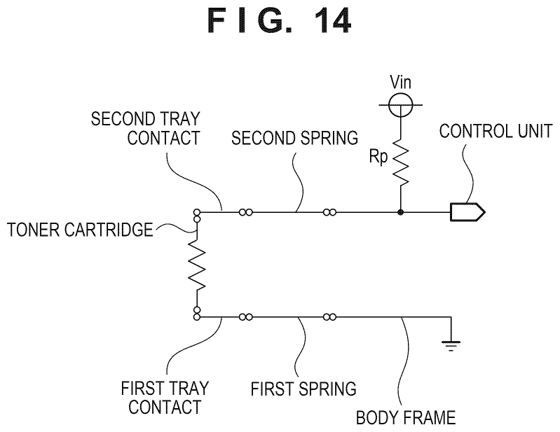

Using FIG. 14, a configuration in which the toner cartridges 7 have electrical characteristics will be described.

Below, the electrical characteristics will be described as resistors that have different resistor values for different color components; however, for example, elements other than resistors, such as capacitors that have different capacitances (electrostatic capacitances) for different color components, may be used. That is to say, a first cartridge includes a first capacitor, a second cartridge includes a second capacitor, and the electrostatic capacitance of the first capacitor is different from the electrostatic capacitance of the second capacitor.

The toner cartridges 7a to 7d include resistors 77a to 77d, respectively, and resistor values of the resistors 77a to 77d are different from one another.

FIG. 14 is a circuit diagram of electrical connection from the control unit to a tray 8 and a toner cartridge 7 according to the present embodiment. The circuit is pulled up between the control unit and a second tray contact 86, a first tray contact 85 is connected to the body frame 100 via a first spring 101, and the body frame 100 is grounded. More specifically, a pull-up resistor Rp and a power source Vin are connected to a second spring 102.

In a case where the toner cartridge 7 is not attached to the tray 8, the second tray contact 86 and the first tray contact 85 are not connected, and thus a current does not flow through the circuit of FIG. 14, and the control unit is in the HI state. When the toner cartridge 7 has been attached to the tray 8, the second tray contact 86 and the first tray contact 85 become connected via the toner cartridge 7, and thus a current flows through the circuit of FIG. 14, and the current value corresponds to the resistor value of the resistor 77 of the toner cartridge 7. Therefore, due to the resistor 77, the control unit has a value between HI and LOW. That is to say, the value of the control unit can be changed by changing the value of the resistor 77. For example, when a toner cartridge 7 of a certain color has been attached to the tray 8, a first current is generated and flows through the circuit, and a signal level (potential) corresponding thereto is input to the toner cartridge detection unit 1503 (or the control unit). Also, when a toner cartridge 7 of another color has been attached to the tray 8, a second current different from the first current is generated and flows through the circuit, and a signal level (potential) corresponding thereto is input to the toner cartridge detection unit 1503 (or the control unit).

In this way, when the toner cartridge 7d has been attached to the tray 8d, the first tray contact 85d and the first toner cartridge contact 71d become connected, and the second tray contact 86d and the second toner cartridge contact 72d become connected. As a result, the electrical substrate on the body side detects the resistor value of the toner cartridge 7d, identifies the color of the attached toner cartridge 7d, and outputs a signal that can be identified for each color component.

In this way, for example, in a case where the toner cartridge 7d has been attached to the tray 8d, a correct resistor value, namely a resistor value of the resistor 77d is detected. On the other hand, in a case where other toner cartridges 77a to 77c have been attached, a wrong resistor value, namely a resistor value other than the resistor value of the resistor 77d is detected. Accordingly, whether a correct toner cartridge has been attached to each tray can be detected. At this time, it is also possible to distinguish the color of the attached toner cartridge 7d from the resistor value and notify the user of the same.

Note that it is possible to perform control to, when a correct toner cartridge 7 has been attached, cause a tray 8 to slide and move to the inside of the rotary 9, from a state where it protrudes outside, by driving the driving source M2. On the other hand, it is also possible to perform control to, when a wrong toner cartridge 7 has been attached, refrain from causing the tray 8 to slide and move to the inside of the rotary 9 without driving the driving source M2.

The configuration and procedure of control according to the present embodiment are basically as shown in FIG. 15 and FIG. 16. However, as stated earlier, the toner cartridge detection unit 1503 is configured to measure a resistor value or a potential difference between the first tray contact 85 and the second tray contact 86, and output a signal corresponding to the measured resistor value or potential difference. Then, the toner cartridge detection unit 1503 converts the measured resistor value or potential difference into, for example, a digital value, and outputs the same as a detection signal. With this configuration, it can be determined that a toner cartridge 7 is in a state where it has been detached from a tray 8 if, for example, the measured resistor value is infinite or the measured potential difference is equal to the applied voltage.

In the configuration according to the present embodiment, the trays 8 may be configured in the same manner regardless of toner color. Also, it is sufficient to configure the toner cartridges 7 so that the resistors 77 are resistors that have resistor values corresponding to the color of toner stored therein. This makes it possible to produce toner cartridges corresponding to different toner colors simply by changing the resistors 77 of the toner cartridges 7, and further suppress a cost increase. Furthermore, attachment of a toner cartridge 7 of a wrong color can be prevented similarly to the first embodiment.

Note that although the above two embodiments have described an image forming apparatus including a rotary provided with developing units, no limitation is intended by this; regarding the configurations of trays and cartridges, application is possible as long as the image forming apparatus is of a type where a cartridge of a corresponding color component is attached to a tray of each color component. Note that the procedure of control at the time of exchange of a cartridge needs to be performed based on a method corresponding to the configuration of the image forming apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention can prevent a developer container from being placed at a wrong attachment position while suppressing an increase in the cost of the developer container.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-062298, filed Apr. 8, 2024 and Japanese Patent Application No. 2025-016288, filed Feb. 3, 2025, which are hereby incorporated by reference herein in their entirety.

What is claimed is:

1. An image forming apparatus to/from which a first cartridge and a second cartridge are attachable/detachable, the first cartridge storing a first developer, and the second cartridge storing a second developer, the image forming apparatus comprising:
a rotary including a first developing chamber configured to store the first developer supplied from the first cartridge, and a second developing chamber configured to store the second developer supplied from the second cartridge;
a first tray by which the first cartridge is attachably/detachably supported, and which is displaced, relative to the rotary, between a first position where the first cartridge is located outside the rotary and a second position where the first cartridge is located inside the rotary, the first tray including a first tray contact member;
a second tray by which the second cartridge is attachably/detachably supported, and which is displaced, relative to the rotary, between a third position where the second cartridge is located outside the rotary and a fourth position where the first cartridge is located inside the rotary, the second tray including a second tray contact member; and
a circuit including the first tray contact member or the second tray contact member and including a detector,
wherein
the first cartridge includes a conductive first cartridge contact member,
the second cartridge includes a conductive second cartridge contact member,
in a case where the first cartridge is supported by the first tray in a state where the first tray is located at the first position, the first cartridge contact member and the first tray contact member come into contact with each other,
in a case where the first tray contact member and the first cartridge contact member have come into contact with each other, a first current is generated in the circuit, and the detector detects a signal that is based on the first current, and
in a case where the second cartridge is supported by the first tray in a state where the first tray is located at the first position, the second cartridge contact member and the first tray contact member do not come into contact with each other, and the first current is not generated in the circuit.

2. The image forming apparatus according to claim 1, wherein
the first cartridge contact member is a conductive wire extending in a longitudinal direction of the first cartridge, and
the second cartridge contact member is a conductive wire extending in a longitudinal direction of the second cartridge.

3. The image forming apparatus according to claim 1, wherein
a direction in which the first tray is displaced from the second position to the first position is a displacement direction, and
in a case where the second cartridge is supported by the first tray in a state where the first tray is located at the first position, the second cartridge contact member and the first tray contact member are located at different positions in the displacement direction.

4. An image forming apparatus to/from which a first cartridge and a second cartridge are attachable/detachable, the first cartridge storing a first developer, and the second cartridge storing a second developer, the image forming apparatus comprising:
a rotary including a first developing chamber configured to store the first developer supplied from the first cartridge, and a second developing chamber configured to store the second developer supplied from the second cartridge;
a first tray by which the first cartridge is attachably/detachably supported, and which is displaced, relative to the rotary, between a first position where the first cartridge is located outside the rotary and a second position where the first cartridge is located inside the rotary, the first tray including a first tray contact member;
a second tray by which the second cartridge is attachably/detachably supported, and which is displaced, relative to the rotary, between a third position where the second cartridge is located outside the rotary and a fourth position where the first cartridge is located inside the rotary, the second tray including a second tray contact member; and
a circuit including the first tray contact member or the second tray contact member and including a detector,
wherein
the first cartridge includes a conductive first cartridge contact member,
the second cartridge includes a conductive second cartridge contact member,
in a case where the first cartridge is supported by the first tray in a state where the first tray is located at the first position, the first cartridge contact member and the first tray contact member come into contact with each other,
in a case where the first tray contact member and the first cartridge contact member have come into contact with each other, a first current is generated in the circuit, and the detector detects a signal that is based on the first current, and
in a case where the second cartridge is supported by the first tray in a state where the first tray is located at the first position, the second cartridge contact member and the first tray contact member come into contact with each other, a second current different from the first current is generated in the circuit, and the detector detects a signal that is based on the second current.

5. The image forming apparatus according to claim 4, wherein
a resistor value of the first cartridge contact member is different from a resistor value of the second cartridge contact member.

6. The image forming apparatus according to claim 4, wherein
the first cartridge includes a first capacitor,
the second cartridge includes a second capacitor, and
an electrostatic capacitance of the first capacitor is different from an electrostatic capacitance of the second capacitor.

7. The image forming apparatus according to claim 1, further comprising:
a moving mechanism that causes the first tray to move between the first position and the second position, and causes the second tray to move between the third position and the fourth position.
